(19) United States
(12) Patent Application Publication
(10) Pub. No.: US 2024/0086837 A1
(43) Pub. Date: Mar. 14, 2024

(54) OUT-OF-STOCK DETECTION APPARATUS, OUT-OF-STOCK DETECTION METHOD, AND NON-TRANSITORY COMPUTER-READABLE STORAGE MEDIUM

(71) Applicant: NEC Corporation, Minato-ku, Tokyo (JP)

(72) Inventors: Rina TOMITA, Tokyo (JP); Yuji TAHARA, Tokyo (JP)

(73) Assignee: NEC Corporation, Minato-ku, Tokyo (JP)

(21) Appl. No.: 18/272,907

(22) PCT Filed: May 20, 2021
(86) PCT No.: PCT/JP2021/019130

§ 371 Date: Jul. 18, 2023

(51) Int. Cl. G06Q 10/087; G06T 5/50; G06V 10/75

(52) U.S. Cl. CPC G06Q 10/087; G06T 5/50; G06V 10/758; G06T 2207/10024; G06V 2201/10

(57) ABSTRACT

An out-of-stock detection apparatus (10) includes an acquisition unit (110) and an image processing unit (120). The acquisition unit (110) acquires a first image including a display shelf on which a product is displayed. The image processing unit (120) determines, by processing the first image, whether a stockout is occurring on the display shelf. The image processing unit (120) generates first statistical information that indicates a result obtained by statistically processing colorfulness of a plurality of pixels included in at least a portion of the first image. The image processing unit (120) determines, using the first statistical information, whether a stockout is occurring on the display shelf. The first statistical information is, for example, an average value.

### TECHNICAL FIELD

The present invention relates to an out-of-stock detection apparatus, an out-of-stock detection method, and a program.

### BACKGROUND ART

In order to prevent loss of sales opportunities of a product at a store, it is desirable to constantly display the product on a display shelf. Therefore, it is desired to promptly recognize that the product on the display shelf is out of stock. In this regard, a display status determination system according to Patent Document 1 determines a display status of the displayed product by processing a captured image of the display shelf to recognize product identifying information of the product and product identifying information of a product tag and comparing these pieces of product identifying information. In addition, this display status determination system determines, among some pieces of product identifying information of price tags, product identifying information that is not included in product identifying information of displayed products, as the product identifying information of an out-of-stock product.

### RELATED DOCUMENTS

### Patent Documents

Patent Document 1: Japanese Unexamined Patent Application Publication No 2019-185684 A

### SUMMARY OF INVENTION

### Technical Problem

It is difficult to accurately detect a stockout of the product when using image processing. An example of objects of the present invention is to accurately detect a stockout of the product by means of image processing.

### Solution to Problem

According to one aspect of the present invention, an out-of-stock detection apparatus is provided, the out-of-stock detection apparatus including:
an acquisition unit that acquires a first image including a display shelf on which a product is displayed; and
an image processing unit that determines, by processing the first image, whether a stockout is occurring on the display shelf, wherein
the image processing unit
   generates first statistical information that indicates a result obtained by statistically processing colorfulness of a plurality of pixels included in at least a portion of the first image, and
   determines, using the first statistical information, whether a stockout is occurring on the display shelf.

According to one aspect of the present invention, an out-of-stock detection method is provided, the out-of-stock detection method causing a computer to perform:
acquisition processing for acquiring a first image including a display shelf on which a product is displayed; and
image processing for determining, by processing the first image, whether a stockout is occurring on the display shelf, wherein
in the image processing, the computer
   generates first statistical information that indicates a result obtained by statistically processing colorfulness of a plurality of pixels included in at least a portion of the first image, and
   determines, using the first statistical information, whether a stockout is occurring on the display shelf.

According to one aspect of the present invention, a program is provided, the program causing a computer to have:
an acquisition function for acquiring a first image including a display shelf on which a product is displayed; and
an image processing function for determining, by processing the first image, whether a stockout is occurring on the display shelf, wherein
the image processing function
generates first statistical information that indicates a result obtained by statistically processing colorfulness of a plurality of pixels included in at least a portion of the first image, and
determines, using the first statistical information, whether a stockout is occurring on the display shelf.

### Advantageous Effects of Invention

According to the present invention, a stockout of the product can be accurately detected by means of image processing.

### BRIEF DESCRIPTION OF THE DRAWINGS

The aforementioned object and other objects, features, and advantages will be more apparent from a preferable example embodiment to be described below and accompanying drawings.

FIG. 1 It is a diagram illustrating a usage environment of an out-of-stock detection apparatus according to an example embodiment.

FIG. 2 It is a diagram illustrating an example of a functional configuration of the out-of-stock detection apparatus.

FIG. 3 It is a diagram for describing a first example of a criterion generated by a criterion generation unit.

FIG. 4 It is a diagram for describing a second example of the criterion generated by the criterion generation unit.

FIG. 5 It is a diagram for describing a second example of the criterion generated by the criterion generation unit.

FIG. 6 It is a diagram illustrating an example of a hardware configuration of the out-of-stock detection apparatus.

FIG. 7 It is a flowchart illustrating a first example of processing performed by the out-of-stock detection apparatus.

FIG. 8 It is a flowchart illustrating a second example of processing performed by the out-of-stock detection apparatus.

### EXAMPLE EMBODIMENT

Hereinafter, an example embodiment of the present invention will be described below using drawings. Note that, in all drawings, like components are denoted by like reference signs and description thereof is not appropriately included.

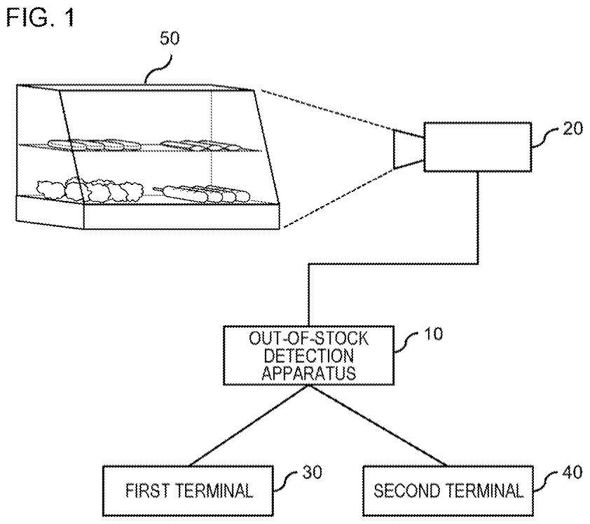

FIG. 1 is a diagram illustrating a usage environment of an out-of-stock detection apparatus 10 according to an example embodiment. The out-of-stock detection apparatus 10 is used in conjunction with an imaging apparatus 20, a first terminal 30, and a second terminal 40.

The imaging apparatus 20 captures an image of the inside of a store. The image generated by the imaging apparatus 20 includes a display shelf for a product. The display shelf may be a general display shelf that does not have a temperature control function, for example, a display shelf that does not have none of a heat-retention function, a refrigeration function, and a freezing function; alternatively, the display shelf may be a display shelf that has a temperature control function. In the former case, products to be displayed on the display shelf have the same appearance if they are the same type. In the latter case, the products to be displayed on the display shelf are, for example, products that are cooked in the store. In this case, the products have slightly different appearances even if they are the same type. In addition, a plurality of types of products may be displayed on a single display shelf.

The out-of-stock detection apparatus 10 determines whether a stockout is occurring on the display shelf by processing the image generated by the imaging apparatus 20. When a stockout is occurring on the display shelf, the out-of-stock detection apparatus 10 then transmits information that indicates occurrence of the stockout (hereinafter, referred to as out-of-stock information) to the first terminal 30. The first terminal 30 is used by a store clerk. The first terminal 30 may be a hand-held terminal, such as a smartphone or a tablet, or a stationary terminal. The first terminal 30 may be a terminal having a database in which a history of out-of-stock conditions is recorded.

The out-of-stock detection apparatus 10 also generates a criterion that is used in determining whether a stockout is occurring by processing a plurality of images including the display shelf. The out-off-stock detection apparatus 10 transmits, when a predetermined criterion is satisfied in the criterion generation processing, information indicating that the predetermined criterion is satisfied to the second terminal 40 that is used by an administrator of the out-of-stock detection apparatus 10. The predetermined criterion is for a case in which it is supposed that accuracy of the aforementioned criterion will be reduced. A specific example of such case will be described later.

Note that the out-of-stock detection apparatus 10 may be installed in each store or the out-of-stock detection apparatus 10 may be a cloud-based apparatus. In the latter case, the out-of-stock detection apparatus 10 acquires an image from each imaging apparatus 20 in a plurality of stores and determines whether a stockout is occurring on the display shelf for each of the plurality of stores. Even in this case, the first terminal 30 is configured for each of the plurality of stores. Therefore, the out-of-stock detection apparatus 10 communicates with a plurality of first terminals 30. When the out-of-stock detection apparatus 10 is cloud-based, there may be one second terminal 40 or more than one second terminal 40.

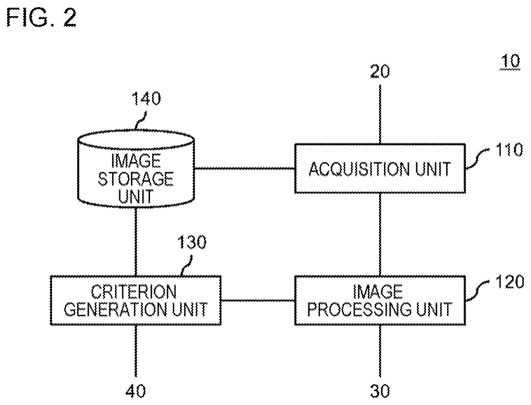

FIG. 2 is a diagram illustrating an example of a functional configuration of the out-of-stock detection apparatus 10. The out-of-stock detection apparatus 10 includes an acquisition unit 110, an image processing unit 120, a criterion generation unit 130, and an image storage unit 140.

The acquisition unit 110 acquires an image generated by the imaging apparatus 20 (hereinafter, referred to as a first image). The first image is an image generated in real time by the imaging apparatus 20. The acquisition unit 110 causes the image storage unit 140 to store the first image. When the out-of-stock detection apparatus 10 manages a plurality of stores, the acquisition unit 110 acquires the first image together with store identifying information. The acquisition unit 110 causes the image storage unit 140 to store the first image associated with the product identifying information. With this operation, the image storage unit 140 can store the first image for each of the plurality of stores.

Note that the first image stored in the image storage unit 140 is used in updating the criterion that is used in determining whether a stockout is occurring.

When a single store is provided with a plurality of display shelves and the imaging apparatus 20 is installed for each of these plurality of display shelves, the acquisition unit 110 acquires the first image together with information for identifying the imaging apparatus 20 that has generated the first image (hereinafter, referred to as imaging apparatus identifying information). The acquisition unit 110 causes the image storage unit 140 to store the first image associated with the imaging apparatus identifying information. With this operation, the image storage unit 140 can store the first image for each of the imaging apparatuses 20, i.e., each of the plurality of display shelves.

The image processing unit 120 determines, by processing the first image acquired in real time by the acquisition unit 110, whether a stockout is occurring on the display shelf. Specifically, the image processing unit 120 generates first statistical information. The first statistical information indicates a result obtained by statistically processing colorfulness of a plurality of pixels included in at least a portion of the first image. An example of processing performed in this case is computation of an average value although it may be processing for computing a representative value by means of an alternative method, such as computation of a mode value. A region of the first image from which the first statistical information is generated may be an entire region of the first image or a region of the first image in which the product is expected to be captured.

The image processing unit 120 determines, using the first statistical information, whether a stockout is occurring on the display shelf. As an example, the image processing unit 120 determines that the product on the display shelf is out of stock when the first statistical information satisfies a predetermined criterion. The criterion used in this case is configured according to at least one of the store and the display shelf. As an example, the criterion may be configured individually according to each of the stores or according to each of the stores and each of the display shelves. This is because lighting conditions of the display shelves vary for each of the stores and each of the display shelves.

When a stockout is occurring on the display shelf, the image processing unit 120 transmits the aforementioned out-of-stock information to the first terminal 30.

The image processing unit 120 may additionally compute at least one of information that indicates a result obtained by statistically processing brightness of the plurality of pixels that have been used in generating the first statistical information (hereinafter, referred to as second statistical information) and information that indicates a result obtained by statistically processing hue of the plurality of pixels (hereinafter, referred to as third statistical information), and further determine whether a stockout is occurring on the display shelf using the at least one of these pieces of information. The second statistical information and the third statistical information are information that indicates a representative value, such as an average value or a mode value.

A specific example of processing performed by the image processing unit 120 will be described later using other diagrams.

The criterion generation unit 130 periodically updates the criterion used by the image processing unit 120 by using the image stored in the image storage unit 140. The image storage unit 140 stores the aforementioned first image as well as includes an image generated by the imaging apparatus 20 before starting operation of the out-of-stock detection apparatus 10 (hereinafter, referred to as a second image). A user of the out-of-stock detection apparatus 10 generates a predetermined number of second images in advance before starting operation of the out-of-stock detection apparatus 10. The criterion generation unit 130 generates the aforementioned criterion by using the predetermined number of second images. The criterion generation unit 130 periodically updates the criterion by using both the first image and the second images. In updating the criterion, the criterion generation unit 130 uses the first image generated in a certain period before the update is made. In this case, the criterion generation unit 130 may update the criterion by using only the first image. The criterion generation unit 130 generates and updates the criterion for each of the stores and each of the display shelves.

As described using FIG. 1, the criterion generation unit 130 transmits, when the predetermined criterion is satisfied in the processing for generating (updating) the criterion, predetermined information to the second terminal 40.

As described above, the image storage unit 140 stores the first image and the second image. As the operating time of the out-of-stock detection apparatus 10 increases, the number of first images stored in the image storage unit 140 increases. Note that the image storage unit 140 may be located outside the out-of-stock detection apparatus 10.

As the second image, an image is selected in such a way that the accuracy of the criterion may not be reduced and used. The criterion for selecting the image here is, for example, that there is little amount of lighting captured on the image and/or that no advertisement is attached to the display shelf. The selection of the second image may be made by means of a model employing machine learning.

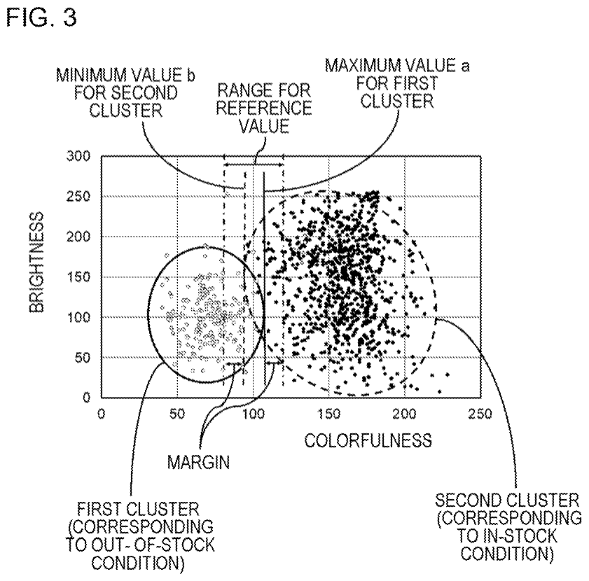

FIG. 3 is a diagram for describing a first example of the criterion generated by the criterion generation unit 130. In the example illustrated in this diagram, the image processing unit 120 and the criterion generation unit 130 use the first statistical information that is related to colorfulness and the second statistical information that is related to brightness.

Specifically, the criterion generation unit 130 first retrieves the first image and the second image from the image storage unit 140. At this point, the retrieved images are not associated with information of whether the product is out of stock.

The criterion generation unit 130 classifies these images into a plurality of clusters using the colorfulness and the brightness. These clusters are based on the number of the products remaining on the display shelf. For example, when the criterion generation unit 130 classifies a plurality of images into a first cluster and a second cluster, a cluster having relatively smaller colorfulness (the first cluster in the example illustrated in FIG. 3) corresponds to an image in which no product is on the display shelf while a cluster having relatively larger colorfulness (the second cluster in the example illustrated in FIG. 3) corresponds to an image in which the product is on the display shelf.

The criterion generation unit 130 generates a criterion by using regions that define each of these clusters.

In the example illustrated in FIG. 3, a region where the first cluster and the second cluster are overlapped is small. The criterion generation unit 130 recognizes a maximum value a of the colorfulness of the first cluster and a minimum value b of the colorfulness of the second cluster. The criterion generation unit 130 sets, as a criterion, a reference value for colorfulness to a value ranging from the minimum value b or more to the maximum value a or less.

The image processing unit 120 determines, when the first statistical information of the first image is equal to or less than the reference value, that the product is out of stock and determines, when the colorfulness of the first image is more than the reference value, that the product is present.

At this point, the criterion generation unit 130 may use, instead of the maximum value a, a value obtained by adding a predetermined margin to the maximum value a. In addition, the criterion generation unit 130 may use, instead of the minimum value b, a value obtained by subtracting the predetermined margin from the minimum value b. The margin used in this case is set to a default value immediately after operation is started, but the margin is subsequently set by, for example, the administrator of the out-of-stock detection apparatus 10 or the store clerk.

In the example illustrated in FIG. 3, the criterion generation unit 130 may set a similar reference value for the brightness. The criterion generation unit 130 may also use, in addition to the colorfulness and the brightness, the third statistical information that is related to hue. In this case, the cluster is defined in a three-dimensional space. The criterion generation unit 130 also sets a similar reference value for the hue.

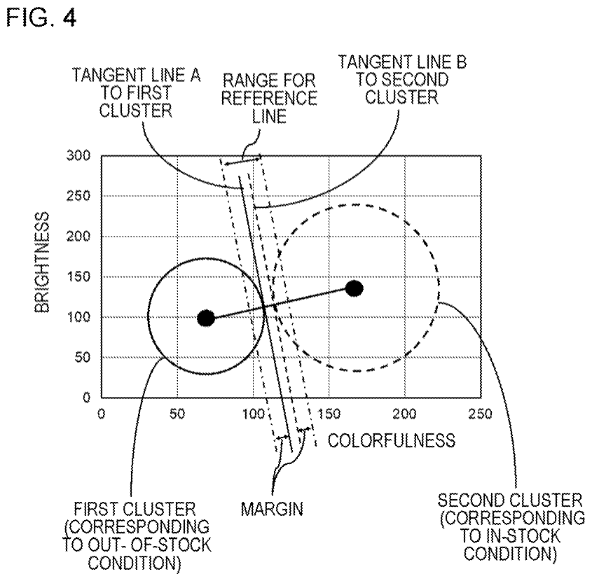

FIG. 4 is a diagram for describing a second example of the criterion generated by the criterion generation unit 130. In the example illustrated in this diagram, the criterion generation unit 130 generates the first cluster and the second cluster in a similar manner to the example illustrated in FIG. 3. The criterion generation unit 130 generates a straight line (hereinafter, referred to as a centerline) connecting a center (or a center of gravity) of the first cluster with a center (or a center of gravity) of the second cluster. The criterion generation unit 130 generates, among tangent lines to a curved line (for example, a circle or an ellipse) that indicates the area of the cluster, tangent lines A and B that are perpendicular to the centerline respectively for the first cluster and the second cluster. The criterion generation unit 130 configures a reference line serving as the criterion in such a way that the reference line is located between and parallel to these two tangent lines A and B.

In the two-dimensional plane illustrated in FIG. 4, the image processing unit 120 determines, when the first image is located on the reference line or nearer to the first cluster than the reference line, that the product is out of stock and determines, when the first image is located nearer to the second cluster than the reference line, that the product is present.

At this point, the criterion generation unit 130 may move at least one of the tangent lines A and B in parallel and extend a configurable range for the reference line. In FIG. 4, the amounts of movement of the tangent lines A and B are referred to as a margin. The amount of movement used in this case is set by, for example, the administrator of the out-of-stock detection apparatus 10 or the store clerk.

In this diagram, the first cluster does not have a region that is overlapped with the second cluster. Note that even if a portion of the first cluster is overlapped with a portion of the second cluster, the example illustrated in this diagram may be applicable.

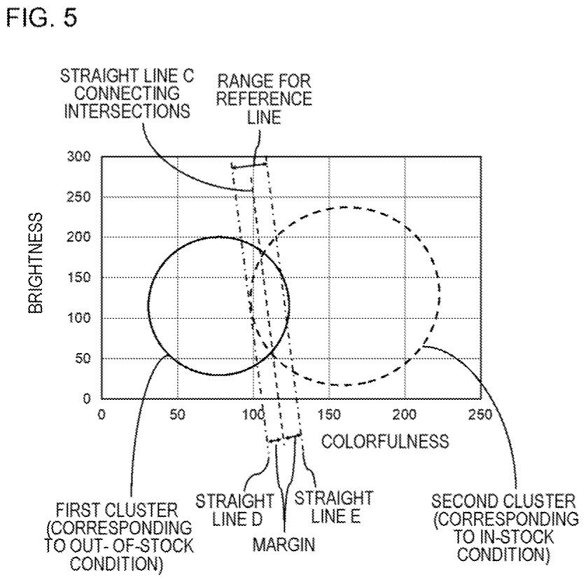

FIG. 5 is a diagram for describing a third example of the criterion generated by the criterion generation unit 130. In the example illustrated in this diagram, the criterion generation unit 130 generates the first cluster and the second cluster in a similar manner to the example illustrated in FIG. 3. A portion of the first cluster is overlapped with a portion of the second cluster. The criterion generation unit 130 determines two intersections between the curved line (for example, a circle or an ellipse) that defines the first cluster and the curved line (for example, a circle or an ellipse) that defines the second cluster. The criterion generation unit 130 generates a straight line C connecting these two intersections. The criterion generation unit 130 generates a straight line D by moving the straight line C in parallel toward the first cluster and a straight line E by moving the straight line C in parallel toward the second cluster. The amounts of movement correspond to the margin in the examples illustrated in FIG. 3 and FIG. 4 and are set by, for example, the administrator of the out-of-stock detection apparatus 10 or the store clerk. The criterion generation unit 130 configures the reference line serving as the criterion in such a way that the reference line is located between and parallel to these two straight lines D and E.

In the two-dimensional plane illustrated in FIG. 5, the image processing unit 120 determines, when the first image is located on the reference line or nearer to the first cluster than the reference line, that the product is out of stock and determines, when the first image is located nearer to the second cluster than the reference line, that the product is present.

The processes described using FIG. 3 to FIG. 5 are performed for each of the stores and each of the display shelves.

In the examples illustrated in FIG. 4 and FIG. 5, the criterion generation unit 130 may further use the third statistical information that is related to hue. In this case, the cluster is defined in a three-dimensional space. The criterion generation unit 130 sets a criterion in the three-dimensional space by performing the processes described above.

In the examples illustrated in FIG. 3, FIG. 4, and FIG. 5, when the first cluster and the second cluster are not formed, the criterion generation unit 130 cannot generate a criterion. In this case, the criterion generation unit 130 transmits information indicating that the criterion cannot be generated to the second terminal 40.

In the examples illustrated in FIG. 3 and FIG. 5, when the area of a region where the first cluster and the second cluster are overlapped is large, the accuracy of the reference value may be reduced. In this case, the criterion generation unit 130 transmits, when the area of the region satisfies a criterion (for example, when the area is equal to or more than a reference value), information indicating that the area of the region satisfies the criterion to the second terminal 40.

In addition, in the examples illustrated in FIG. 3 to FIG. 5, the images retrieved from the image storage unit 140 may be classified into three or more clusters. In this case, the criterion generation unit 130 transmits information indicating that the images may be classified into three or more clusters to the second terminal 40. Alternatively, the criterion generation unit 130 may remove a predetermined cluster and reduce the number of clusters to two. In this case, the criterion generation unit 130 selects the cluster to be removed by, for example, using at least one of the colorfulness of the cluster and the number of images belonging to the cluster.

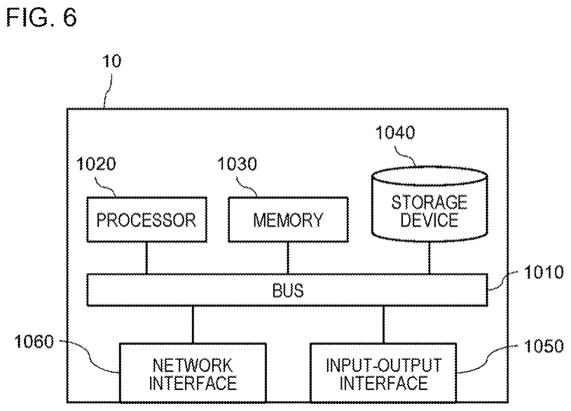

FIG. 6 is a diagram illustrating an example of a hardware configuration of the out-of-stock detection apparatus 10. The out-of-stock detection apparatus 10 includes a bus 1010, a processor 1020, memory 1030, a storage device 1040, an input-output interface 1050, and a network interface 1060.

The bus 1010 is a data transmission line for the processor 1020, the memory 1030, the storage device 1040, the input-output interface 1050, and the network interface 1060 to mutually transmit and receive data. However, a method for mutually connecting the processor 1020 and the like is not limited to a bus connection.

The processor 1020 is a processor implemented by means of a CPU (Central Processing Unit), a GPU (Graphics Processing Unit), or the like.

The memory 1030 is main memory implemented by means of RAM (Random Access Memory) or the like.

The storage device 1040 is an auxiliary storage device implemented by means of an HDD (Hard Disk Drive), an SSD (Solid State Drive), a memory card, ROM (Read Only Memory), or the like. The storage device 1040 stores program modules each of which enables a function of the out-of-stock detection apparatus 10 (for example, the acquisition unit 110, the image processing unit 120, and the criterion generation unit 130). These program modules are read into the memory 1030 and executed by the processor 1020, and functions associated with the program modules are achieved. The storage device 1040 also serves as the image storage unit 140.

The input-output interface 1050 is an interface for connecting the out-of-stock detection apparatus 10 with various types of input-output devices.

The network interface 1060 is an interface for connecting the out-of-stock detection apparatus 10 to a network. The network is, for example, a LAN (Local Area Network) or a WAN (Wide Area Network). The method for connecting the network interface 1060 to the network may be a wireless connection or a wired connection. The out-of-stock detection apparatus 10 communicates with the imaging apparatus 20, the first terminal 30, and the second terminal 40 via, for example, the network interface 1060.

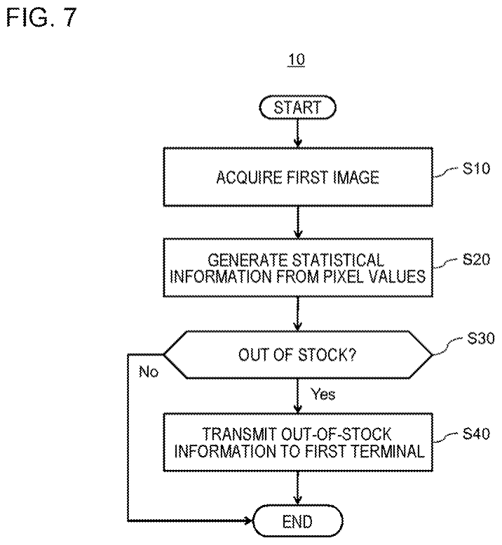

FIG. 7 is a flowchart illustrating a first example of processing performed by the out-of-stock detection apparatus 10. The criterion generation unit 130 generates the criterion in advance. The criterion is stored, for example, in the image storage unit 140. The imaging apparatus 20 repeatedly captures an image of the display shelf. The imaging apparatus 20 transmits the image in real time to the out-of-stock detection apparatus 10 as the first image at regular intervals. The out-of-stock detection apparatus 10 performs the process described in this diagram every time the out-of-stock detection apparatus 10 acquires the first image. Note that the out-of-stock detection apparatus 10 may automatically start the process described in this diagram, or start the process when receiving a predetermined input from the administrator or the store clerk.

The acquisition unit 110 of the out-of-stock detection apparatus 10 acquires the first image from the imaging apparatus 20 (step S10). The acquisition unit 110 causes the image storage unit 140 to store the first image.

Subsequently, the image processing unit 120 generates, by processing the first image acquired in step S10, the first statistical information. At this point, the image processing unit 120 also generates the second statistical information and the third statistical information as necessary (step S20). Subsequently, the criterion generation unit 130 determines whether the product on the display shelf is out of stock by using the information generated in step S20 and the criterion that has been generated by the criterion generation unit 130 in advance (step S30). When the criterion generation unit 130 determines that the product is out of stock (Yes in step S30), the criterion generation unit 130 transmits the out-of-stock information to the first terminal 30 (step S40).

The first terminal 30 informs the store clerk that the out-of-stock information has been transmitted, for example, by means of sound or vibration. On acquiring the out-of-stock information, the store clerk performs a task of restocking the product on the display shelf.

As described using FIG. 1, a plurality of types of products may be displayed on a single display shelf. In this case, a position at which the product is to be displayed has been specified according to the type of the product. Therefore, the out-of-stock detection apparatus 10 may extract a region associated with the type of the product for each type of product from each of the first image and the second image and perform the process described above using the extracted regions instead of the first image and the second image. In this case, the criterion is also generated in a similar manner.

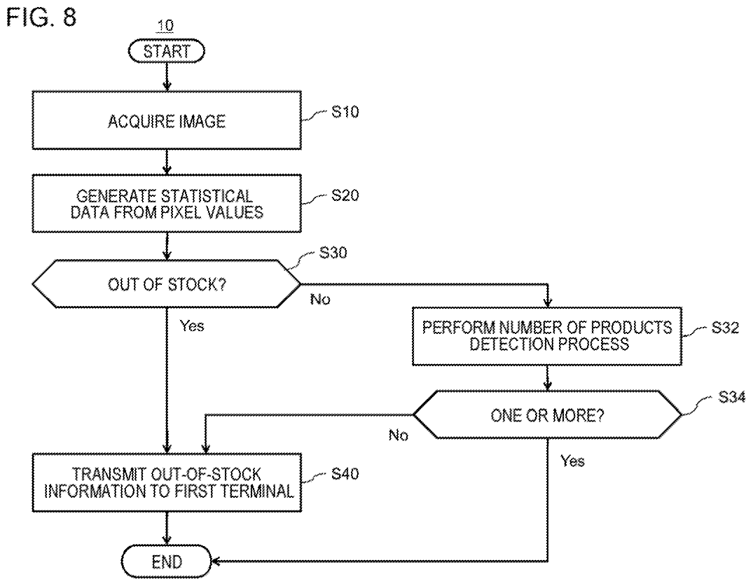

FIG. 8 is a flowchart illustrating a second example of processing performed by the out-of-stock detection apparatus 10. In this diagram, the processing in step S10 to step S30 (Yes) and step S40 are similar to the processing in the example illustrated in FIG. 7.

When the image processing unit 120 determines that the stockout is not occurring (No in step S30), the image processing unit 120 performs, on the first image, processing for detecting the number of the products. This processing may be performed, for example, using a feature value of the product or by means of a model generated by means of machine learning (step S32). When the image processing unit 120 determines that the number of the products is zero (No in step S34), the image processing unit 120 performs the processing described in step S40.

When an accompanying item (such as an advertisement) is provided on the display shelf or when a portion of the display shelf reflects the lighting, at least one of the first statistical information, the second statistical information, and the third statistical information of the first image (especially the first statistical information) may have a great value due to the accompanying item. In this case, in the processing described in step S20 and step S30, it may be falsely recognized that the product is remaining even though the product is out of stock. In contrast, when the processing described in step S32 and the processing described in step S34 are performed, the false recognition can be corrected.

When it is determined in step S34 that the number of the products is zero, the criterion generation unit 130 may perform the following processing. The criterion generation unit 130 first computes a distance between a center (or a center of gravity) of the first cluster and the first image acquired in step S10 in the plane illustrated in FIG. 3 to FIG. 5. When the distance is equal to or more than the reference value, the accuracy of the first cluster may be reduced due to the environment of the display shelf (such as the lighting condition or the accompanying item). In this case, the criterion generation unit 130 transmits information indicating that the accuracy of the first cluster may be reduced to the second terminal 40. Note that this processing may be performed by the image processing unit 120. In this case, the image processing unit 120 transmits the aforementioned information to the first terminal 30. This transmission processing may be performed every time the aforementioned distance is equal to or more than the reference value or when the number of times that the aforementioned distance is equal to or more than the reference value reaches a reference number of times.

As described above, according to the present example embodiment, the out-of-stock detection apparatus 10 can accurately detect a stockout of the product by means of image processing. In addition, the detection of a stockout requires a small computation amount.

The example embodiment according to the present invention has been described above with reference to the drawings although it is merely an example of the present invention and various configurations other than those described above may be employed.

Although a plurality of steps (processing) are described in a sequential order in the flowcharts used in the foregoing description, the sequence of the steps to be performed in each example embodiment is not limited to the illustrated order. In each example embodiment, orders of the illustrated steps may be changed as long as there is no inconsistency. Example embodiments described above may be combined as long as those example embodiments do not conflict each other.

Some or all of the example embodiments described above may be described as in the following supplementary notes, but are not limited to the following.

1. An out-of-stock detection apparatus, including:
an acquisition unit that acquires a first image including a display shelf on which a product is displayed; and
an image processing unit that determines, by processing the first image, whether a stockout is occurring on the display shelf, wherein
the image processing unit
   generates first statistical information that indicates a result obtained by statistically processing colorfulness of a plurality of pixels included in at least a portion of the first image, and
   determines, using the first statistical information, whether a stockout is occurring on the display shelf.

2. The out-of-stock detection apparatus according to supplementary note 1, wherein
the first statistical information includes an average value of the colorfulness.

3. The out-of-stock detection apparatus according to supplementary note 1 or 2, including:
a criterion generation unit that generates a criterion for determining whether a stockout is occurring on the display shelf, wherein
the image processing unit determines, using the criterion, whether a stockout is occurring on the display shelf, and
the criterion generation unit
   classifies a plurality of images including the display shelf into a plurality of clusters using the colorfulness; and
   generates the criterion using the plurality of clusters.

4. The out-of-stock detection apparatus according to supplementary note 3, wherein
the image processing unit transmits, when a stockout is occurring on the display shelf, information that indicates occurrence of the stockout to a first terminal, and
the criterion generation unit transmits, when a predetermined condition is satisfied in the processing for generating the criterion, information that indicates that the predetermined condition is satisfied to a second terminal.

5. The out-of-stock detection apparatus according to any one of supplementary notes 1 to 4, wherein
the image processing unit
   generates second statistical information that indicates a result obtained by statistically processing brightness of the plurality of pixels, and
   determines, using the first statistical information and the second statistical information, whether a stockout is occurring on the display shelf.

6. The out-of-stock detection apparatus according to any one of supplementary notes 1 to 5, wherein
the image processing unit
   generates third statistical information that indicates a result obtained by statistically processing hue of the plurality of pixels, and
   determines, using the first statistical information and the third statistical information, whether a stockout is occurring on the display shelf.

7. The out-of-stock detection apparatus according to any one of supplementary notes 1 to 6, wherein
according to at least one of a position of the display shelf in a store and the store in which the display shelf is displayed, a criterion for determining whether a stockout is occurring on the display shelf is configured.

8. The out-of-stock detection apparatus according to any one of supplementary notes 1 to 7, wherein
when the image processing unit determines, using the first statistical information, that a stockout is not occurring on the display shelf, the image processing unit
   further performs, on the first image, processing for detecting the number of the products in which the number of the products is detected, and
   determines, when it is determined in the processing for detecting the number of the products that the number of the products is zero, that a stockout is occurring on the display shelf.

9. An out-of-stock detection method, the method causing a computer to perform:
acquisition processing for acquiring a first image including a display shelf on which a product is displayed; and
image processing for determining, by processing the first image, whether a stockout is occurring on the display shelf, wherein
in the image processing, the computer
generates first statistical information that indicates a result obtained by statistically processing colorfulness of a plurality of pixels included in at least a portion of the first image, and
determines, using the first statistical information, whether a stockout is occurring on the display shelf.

10. The out-of-stock detection method according to supplementary note 9, wherein
the first statistical information includes an average value of the colorfulness.

11. The out-of-stock detection method according to supplementary note 9 or 10, wherein
the computer
   performs a criterion generation processing for generating a criterion for determining whether a stockout is occurring on the display shelf,
   in the image processing, determines, using the criterion, whether a stockout is occurring on the display shelf, and
   in the criterion generation processing,
      classifies a plurality of images including the display shelf into a plurality of clusters using the colorfulness; and
      generates the criterion using the plurality of clusters.

12. The out-of-stock detection method according to supplementary note 11, wherein
the computer
   in the image processing, transmits, when a stockout is occurring on the display shelf, information that indicates occurrence of the stockout to a first terminal, and
   in the criterion generation processing, transmits, when a predetermined condition is satisfied, information that indicates that the predetermined condition is satisfied to a second terminal.

13. The out-of-stock detection method according to any one of supplementary notes 9 to 12, wherein
in the image processing, the computer
   generates second statistical information that indicates a result obtained by statistically processing brightness of the plurality of pixels, and
   determines, using the first statistical information and the second statistical information, whether a stockout is occurring on the display shelf.

14. The out-of-stock detection method according to any one of supplementary notes 9 to 13, wherein
in the image processing, the computer
   generates third statistical information that indicates a result obtained by statistically processing hue of the plurality of pixels, and
   determines, using the first statistical information and the third statistical information, whether a stockout is occurring on the display shelf.

15. The out-of-stock detection method according to any one of supplementary notes 9 to 14, wherein
according to at least one of a position of the display shelf in a store and the store in which the display shelf is displayed, a criterion for determining whether a stockout is occurring on the display shelf is configured.

16. The out-of-stock detection method according to any one of supplementary notes 9 to 15, wherein
in the image processing,
   when the computer determines, using the first statistical information, that a stockout is not occurring on the display shelf, the computer
      further performs, on the first image, processing for detecting the number of the products in which the number of the products is detected, and
      determines, when it is determined in the processing for detecting the number of the products that the number of the products is zero, that a stockout is occurring on the display shelf.

17. A program causing a computer to have:
an acquisition function for acquiring a first image including a display shelf on which a product is displayed; and
an image processing function for determining, by processing the first image, whether a stockout is occurring on the display shelf, wherein
the image processing function
generates first statistical information that indicates a result obtained by statistically processing colorfulness of a plurality of pixels included in at least a portion of the first image, and
determines, using the first statistical information, whether a stockout is occurring on the display shelf.

18. The program according to supplementary note 17, wherein
the first statistical information includes an average value of the colorfulness.

19. The program according to supplementary note 17 or 18, wherein
the program causes the computer to have a criterion generation function for generating a criterion for determining whether a stockout is occurring on the display shelf,
the image processing function determines, using the criterion, whether a stockout is occurring on the display shelf, and
the criterion generation function
   classifies a plurality of images including the display shelf into a plurality of clusters using the colorfulness; and
   generates the criterion using the plurality of clusters.

20. The program according to supplementary note 19, wherein
the image processing function transmits, when a stockout is occurring on the display shelf, information that indicates occurrence of the stockout to a first terminal, and
the criterion generation function transmits, when a predetermined condition is satisfied in the processing for generating the criterion, information that indicates that the predetermined condition is satisfied to a second terminal.

21. The program according to any one of supplementary notes 17 to 20, wherein
the image processing function
   generates second statistical information that indicates a result obtained by statistically processing brightness of the plurality of pixels, and
   determines, using the first statistical information and the second statistical information, whether a stockout is occurring on the display shelf.

22. The program according to any one of supplementary notes 17 to 21, wherein
the image processing function
   generates third statistical information that indicates a result obtained by statistically processing hue of the plurality of pixels, and
   determines, using the first statistical information and the third statistical information, whether a stockout is occurring on the display shelf.

23. The program according to any one of supplementary notes 17 to 22, wherein
according to at least one of a position of the display shelf in a store and the store in which the display shelf is displayed, a criterion for determining whether a stockout is occurring on the display shelf is configured.

24. The program according to any one of supplementary notes 17 to 23, wherein
when the image processing function determines, using the first statistical information, that a stockout is not occurring on the display shelf, the image processing function
   further performs, on the first image, processing for detecting the number of the products in which the number of the products is detected, and
   determines, when it is determined in the processing for detecting the number of the products that the number of the products is zero, that a stockout is occurring on the display shelf.

### REFERENCE SIGNS LIST

10 Out-of-stock detection apparatus
20 Imaging apparatus
30 First terminal
40 Second terminal
110 Acquisition unit
120 Image processing unit
130 Criterion generation unit
140 Image storage unit

What is claimed is:

1. An out-of-stock detection apparatus, comprising:
at least one memory confiqured to store instructions; and
at least one processor confiqured to execute the instructions to:
acquire a first image including a display shelf on which a product is displayed;
determine, by processing the first image, whether a stockout is occurring on the display shelf;
generate first statistical information that indicates a result obtained by statistically processing colorfulness of a plurality of pixels included in at least a portion of the first image;
determine, using the first statistical information, whether a stockout is occurring on the display shelf.

2. The out-of-stock detection apparatus according to claim 1, wherein
the first statistical information includes an average value of the colorfulness.

3. The out-of-stock detection apparatus according to claim 1,
wherein the at least one processor is further confiqured to execute the instructions to:
generate a generates a criterion for determining whether a stockout is occurring on the display shelf;
determine, using the criterion, whether a stockout is occurring on the display shelf;
classify a plurality of images including the display shelf into a plurality of clusters using the colorfulness; and
determine the criterion using the plurality of clusters.

4. The out-of-stock detection apparatus according to claim 3, wherein
the at least one processor is further confiqured to execute the instructions to:
transmit, when a stockout is occurring on the display shelf, information that indicates occurrence of the stockout to a first terminal;
transmit, when a predetermined condition is satisfied in the processing for generating the criterion, information that indicates that the predetermined condition is satisfied to a second terminal.

5. The out-of-stock detection apparatus according to claim 1, wherein
the at least one processor is further confiqured to execute the instructions to:
generates second statistical information that indicates a result obtained by statistically processing brightness of the plurality of pixels, and
determines, using the first statistical information and the second statistical information, whether a stockout is occurring on the display shelf.

6. The out-of-stock detection apparatus according to claim 1, wherein
the at least one processor is further confiqured to execute the instructions to:
generates third statistical information that indicates a result obtained by statistically processing hue of the plurality of pixels, and
determines, using the first statistical information and the third statistical information, whether a stockout is occurring on the display shelf.

7. The out-of-stock detection apparatus according to claim 1, wherein
according to at least one of a position of the display shelf in a store and the store in which the display shelf is displayed, a criterion for determining whether a stockout is occurring on the display shelf is configured.

8. The out-of-stock detection apparatus according to claim 1, wherein
the at least one processor is further confiqured to execute the instructions to:
when the image processing unit determines, using the first statistical information, that a stockout is not occurring on the display shelf, the image processing unit
further performs, on the first image, processing for detecting the number of the products in which the number of the products is detected, and
determines, when it is determined in the processing for detecting the number of the products that the number of the products is zero, that a stockout is occurring on the display shelf.

9. An out-of-stock detection method performed by a computer perform, and comprising:
acquiring a first image including a display shelf on which a product is displayed;
determining, by processing the first image, whether a stockout is occurring on the display shelf;
generating first statistical information that indicates a result obtained by statistically processing colorfulness of a plurality of pixels included in at least a portion of the first image;
determining, using the first statistical information, whether a stockout is occurring on the display shelf.

10. A non-transitory computer-readable storage medium storing a program causing a computer to execute:
a process of acquiring a first image including a display shelf on which a product is displayed;
a process of determining, by processing the first image, whether a stockout is occurring on the display shelf;
a process of generating first statistical information that indicates a result obtained by statistically processing colorfulness of a plurality of pixels included in at least a portion of the first image; and
a process of determining, using the first statistical information, whether a stockout is occurring on the display shelf.
